(19) United States
(12) Patent Application Publication
(10) Pub. No.: US 2012/0198394 A1
(43) Pub. Date: Aug. 2, 2012

(54) Method For Improving Circuit Design Robustness

(76) Inventors: FEDOR G. PIKUS, Beaverton, OR (US); Kareem Madkour, Cairo (EG)

(21) Appl. No.: 13/018,204

(22) Filed: Jan. 31, 2011

(51) Int. Cl. G06F 17/50

(52) U.S. Cl. 716/53; 716/104

(57) ABSTRACT

Improving circuit design robustness is based on identifying process sensitive and design critical devices. Design critical devices are identified using circuit design information. Various model-based simulations may be performed on the layout areas associated with the identified design critical devices to extract process sensitive and design critical devices. To make the circuit design more robust, various techniques may be employed to treat the extracted process sensitive and design critical devices.

### FIELD OF THE INVENTION

The present invention relates to integrated circuit design and manufacturing. Various aspects of the invention may be particularly useful for improving circuit design robustness.

### BACKGROUND OF THE INVENTION

In 1965, Gordon Moore was the first to observe that the cost of integrated circuits was minimized by doubling the number of components (transistors) on an integrated circuit (IC) every year. Although Moore altered the magnitude of his predictions in 1975, the fundamental economic justifications have remained unchanged for almost half a century. During the last decade, the industry failed to decrease the wavelength below the wavelength of 193 nm even after spending several hundreds of millions of dollars on research and development. As a result, the 193 nm lithography has been used for five generations spanning from the 90 nm technology node to the 22 nm technology node. During this period, the manufacturing process improvement has been achieved through resolution enhancement techniques (RETs) as well as water immersion lithography. RETs, including off-axis illumination (OAI) with sub-resolution assist features (SRAF), optical proximity correction (OPC), double patterning technology (DPT) and source mask optimization (SMO), improve resolution by lowering Rayleigh's k₁ factor. In particular, DPT and SMO used by 193 nm water immersion lithography could enable volume manufacturing with a k₁ factor as low as 0.28 at the 22 nm technology mode.

Unfortunately, the aggressive k₁ scaling has led to a considerable loss in pattern fidelity and has introduced severe and complex layout sensitivities leading to physical and electrical yield losses despite the increasing complexity and cost of RETs. The layout sensitivities may be minimized by making designs RET-compliant. For example, the effective use of advanced OAI solutions, such as dipole illumination, requires layout designs to be unidirectional. To ensure that layouts are made RET-compliant while maintaining design intent, lithographers have been working more closely with layout engineers to eliminate non-RET-compliant layout patterns from the design. Through mutual collaboration they have defined a set of design for manufacturability (DFM) rules that extend the application of design rules to create RET-compliant designs. This trend of adding more complex design rules has led to the escalation in design rule complexity. Even with the added complexity, however, design rules cannot provide absolute assurance that a design-rule-clean layout will yield or perform adequately. This is in part due to the fact that design rules are incapable to capture all the two-dimensional effects and identify yield limiting shapes. Therefore, computationally intensive model-based layout legalization techniques are needed. These techniques can model lithography, etch, chemical mechanical polishing (CMP), strain, and other physical effects, and predict the locations of yield detractors that are often termed as “hotspots.”

While it has been the enabler of Moore's Law, dimensional scaling alone is no longer sufficient to achieve the electrical performance targets of the next technology node. Variability from both random defects and systematic effects has been increasing. As the feature sizes of transistors and interconnects are comparable to the characteristic lengths of random effects such as random dopant fluctuation (RDF) and line-edge roughness (LER), a significant increase in random variability has been experienced. The layout dependent systematic variability has also increased primarily due to additional device, interconnect and process innovations introduced with every new technology node. These random and systematic variations can degrade both functional yield and parametric yield. While functional yield concerns the percentage of dies that can perform certain functions, parametric yield is defined as the percentage of dies that satisfy the specified frequency and power constraints. With fluctuations in process parameters, a large set of dies may not meet the power or performance budget of the design. This causes significant parametric yield losses as such chips cannot be shipped despite being functionally correct.

A conventional approach to modeling variability is based on “worst case scenarios (corner cases). This approach assumes all transistors are independent and hence yields overly pessimistic simulations, making the design unnecessarily difficult. In fact, more than 50% of gate length variation may be due to systematic sources, which can be modeled rather accurately once the layout design is completed. Comprehensive analysis of modern designs using multiple model-based tools, however, is extremely expensive and not always possible. For example, accurate process models are not available to the early adopters of a new process. It is thus desirable to target the best available analysis capabilities at the parts of the design where the results of such analysis are critically important for the performance of the chip.

### BRIEF SUMMARY OF THE INVENTION

Aspects of the invention relate to improving circuit design robustness based on identifying process sensitive and design critical devices. Technology scaling has increased the layout dependent systematic variability dominated by lithography and stress effects. A significant number of devices in a circuit design are sensitive to lithography and stress effects and are denoted as process sensitive devices. However, only a small fraction of these process sensitive devices have a significant effect on the circuit performance. This small fraction is the overlap between the process sensitive device set and the design critical device set. With various implementations of the invention, the set of design critical devices are identified through analyzing the circuit design information. The circuit design information may be extracted from the layout design if it is not available. Various model-based simulations may be performed on the layout areas associated with the identified design critical devices to extract process sensitive and design critical devices. To make the circuit design more robust, various techniques may be employed to treat the extracted process sensitive and design critical devices.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 illustrates process sensitive and design critical devices.

FIG. 4 illustrates an example of a tool for improving circuit design robustness.

### DETAILED DESCRIPTION OF THE INVENTION

Various aspects of the present invention relate to improving circuit design robustness based on identifying process sensitive and design critical devices. In the following description, numerous details are set forth for the purpose of explanation. However, one of ordinary skill in the art will realize that the invention may be practiced without the use of these specific details. In other instances, well-known features have not been described in details to avoid obscuring the present invention.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “identify”, “extract” and “derive” to describe the disclosed methods. Such terms are high-level abstractions of the actual operations that are performed. The actual operations that correspond to these terms will vary depending on the particular implementation and are readily discernible by one of ordinary skill in the art.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one microdevice, such as data to be used to form multiple microdevices on a single wafer.

Operating Environment

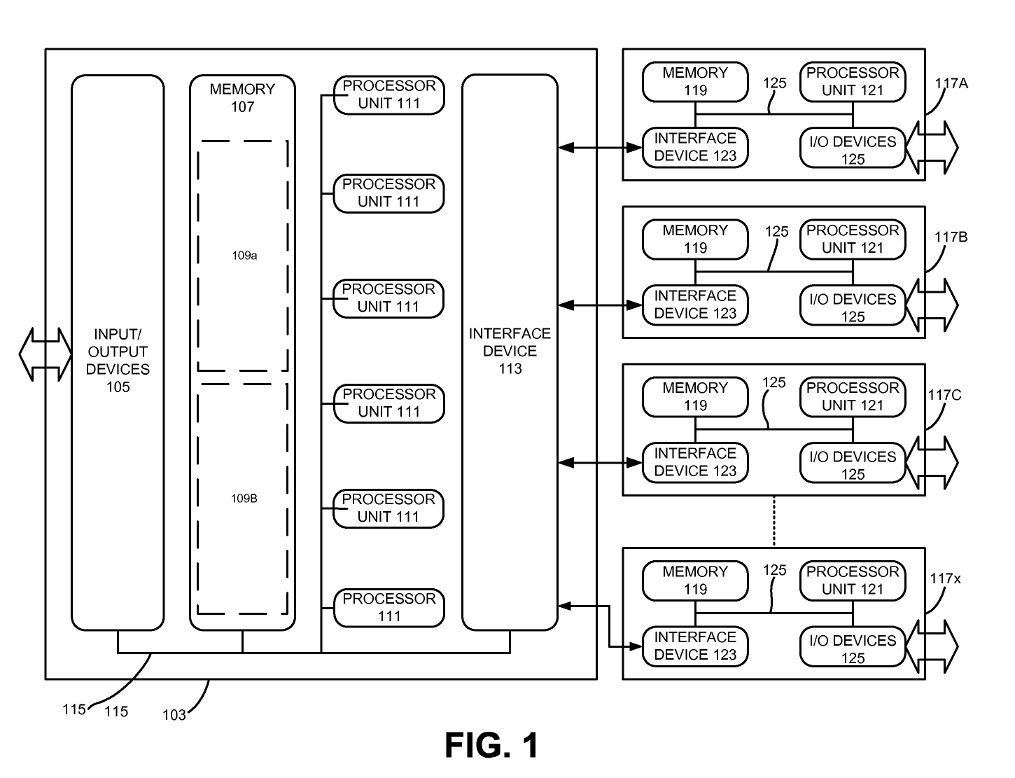

The execution of various electronic design automation processes may be implemented using computer-executable software instructions executed by one or more programmable computing devices. Because these examples of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or slave computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

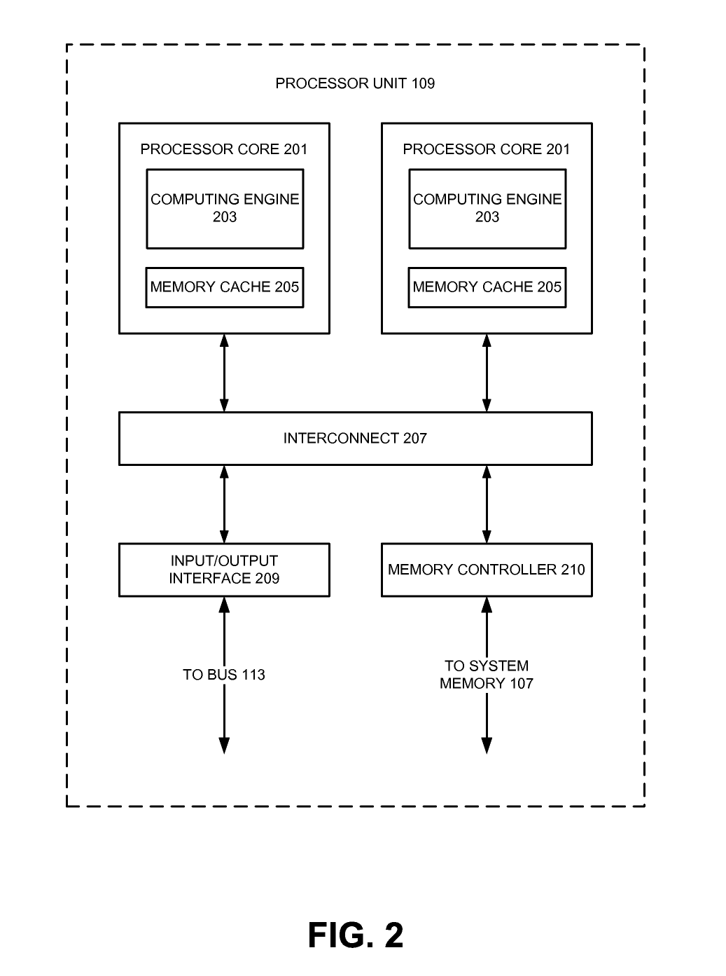

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the slave computers 117A, 1157, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 122, and, optionally, one more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the invention may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers, it should be noted that, with alternate embodiments of the invention, either the computer 103, one or more of the slave computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 117 may alternately or additions be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

Electronic Design Automation

As previously noted, various embodiments of the invention are related to electronic design automation. In particular, various implementations of the invention may be used to improve the operation of electronic design automation software tools that identify, verify and/or modify design data for manufacturing a microdevice, such as a microcircuit. As used herein, the terms “design” and “design data” are intended to encompass data describing an entire microdevice, such as an integrated circuit device or micro-electromechanical system (MEMS) device. This term also is intended to encompass a smaller set of data describing one or more components of an entire microdevice, however, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer. It should be noted that, unless otherwise specified, the term “design” as used herein is intended to encompass any type of design, including both a physical layout design and a logical design.

Designing and fabricating microcircuit devices involve many steps during a ‘design flow’ process. These steps are highly dependent on the type of microcircuit, its complexity, the design team, and the fabricator or foundry that will manufacture the microcircuit from the design. Several steps are common to most design flows, however. First, a design specification is modeled logically, typically in a hardware design language (HDL). Once a logical design has been created, various logical analysis processes are performed on the design to verify its correctness. More particularly, software and hardware “tools” verify that the logical design will provide the desired functionality at various stages of the design flow by running software simulators and/or hardware emulators, and errors are corrected. For example, a designer may employ one or more functional logic verification processes to verify that, given a specified input, the devices in a logical design will perform in the desired manner and provide the appropriate output.

In addition to verifying that the devices in a logic design will provide the desired functionality, some designers may employ a design logic verification process to verify that the logical design meets specified design requirements. For example, a designer may create rules such as, e.g., every transistor gate in the design must have an electrical path to ground that passes through no more than three other devices, or every transistor that connects to a specified power supply also must be connected to a corresponding ground node, and not to any other ground node. A design logic verification process then will determine if a logical design complies with specified rules, and identify occurrences where it does not.

After the logical design is deemed satisfactory, it is converted into physical design data by synthesis software. This physical design data or “layout” design data may represent, for example, the geometric elements that will be written onto a mask used to fabricate the desired microcircuit device in a photolithographic process at a foundry. For conventional mask or reticle writing tools, the geometric elements typically will be polygons of various shapes. Thus, the layout design data usually includes polygon data describing the features of polygons in the design. It is very important that the physical design information accurately embody the design specification and logical design for proper operation of the device. Accordingly, after it has been created during a synthesis process, the physical design data is compared with the original logical design schematic in a process sometimes referred to as a “layout-versus-schematic” (LVS) process.

Once the correctness of the logical design has been verified, and geometric data corresponding to the logical design has been created in a layout design, the geometric data then may be analyzed. For example, because the physical design data is employed to create masks used at a foundry, the data must conform to the foundry's requirements.

Each foundry specifies its own physical design parameters for compliance with their processes, equipment, and techniques. Accordingly, the design flow may include a process to confirm that the design data complies with the specified parameters. During this process, the physical layout of the circuit design is compared with design rules in a process commonly referred to as a “design rule check” (DRC) process. In addition to rules specified by the foundry, the design rule check process may also check the physical layout of the circuit design against other design rules, such as those obtained from test chips, general knowledge in the industry, previous manufacturing experience, etc.

With modern electronic design automation design flows, a designer may additionally employ one or more “design-for-manufacture” (DFM) software tools. As previously noted, design rule check processes attempt to identify, e.g., elements representing structures that will almost certainly be improperly formed during a manufacturing process. “Design-For-Manufacture” tools, however, provide processes that attempt to identify elements in a design representing structures with a significant likelihood of being improperly formed during the manufacturing process. A “design-for-manufacture” process may additionally determine what impact the improper formation of the identified elements will have on the yield of devices manufactured from the circuit design, and/or modifications that will reduce the likelihood that the identified elements will be improperly formed during the manufacturing process. For example, a “design-for-manufacture” (DFM) software tool may identify wires that are connected by only a single via, determine the yield impact for manufacturing a circuit from the design based upon the probability that each individual single via will be improperly formed during the manufacturing process, and then identify areas where redundant vias can be formed to supplement the single vias.

It should be noted that, in addition to “design-for-manufacture,” various alternate terms are used in the electronic design automation industry. Accordingly, as used herein, the term “design-for-manufacture” or “design-for-manufacturing” is intended to encompass any electronic design automation process that identifies elements in a design representing structures that may be improperly formed during the manufacturing process. Thus, “design-for-manufacture” (DFM) software tools will include, for example, “lithographic friendly design” (LFD) tools that assist designers to make trade-off decisions on how to create a circuit design that is more robust and less sensitive to lithographic process windows. They will also include “design-for-yield” (DFY) electronic design automation tools, “yield assistance” electronic design automation tools, and “chip cleaning” and “design cleaning” electronic design automation tools.

After a designer has used one or more geometry analysis processes to verify that the physical layout of the circuit design is satisfactory, the designer may then perform one or more simulation processes to simulate the operation of a manufacturing process, in order to determine how the design will actually be realized by that particular manufacturing process. A simulation analysis process may additionally modify the design to address any problems identified by the simulation. For example, some design flows may employ one or more processes to simulate the image formed by the physical layout of the circuit design during a photolithographic process, and then modify the layout design to improve the resolution of the image that it will produce during a photolithography process.

These resolution enhancement techniques (RET) may include, for example, modifying the physical layout using optical proximity correction (OPC) or by the addition of sub-resolution assist features (SRAF). Other simulation analysis processes may include, for example, phase shift mask (PSM) simulation analysis processes, etch simulation analysis processes and planarization simulation analysis processes. Etch simulation analysis processes simulate the removal of materials during a chemical etching process, while planarization simulation processes simulate the polishing of the circuit's surface during a chemical-mechanical etching process. These simulation analysis processes may identify, for example, regions where an etch or polishing process will not leave a sufficiently planar surface. These simulation analysis processes may then modify the physical layout design to, e.g., include more geometric elements in those regions to increase their density.

Once a physical layout design has been finalized, the geometric elements in the design are formatted for use by a mask or reticle writing tool. Masks and reticles typically are made using tools that expose a blank reticle or mask substrate to an electron or laser beam (or to an array of electron beams or laser beams), but most mask writing tools are able to only “write” certain kinds of polygons, however, such as right triangles, rectangles or other trapezoids. Moreover, the sizes of the polygons are limited physically by the maximum beam (or beam array) size available to the tool. Accordingly, the larger geometric elements in a physical layout design data will typically be “fractured” into the smaller, more basic polygons that can be written by the mask or reticle writing tool.

It should be appreciated that various design flows may repeat one or more processes in any desired order. Thus, with some design flows, geometric analysis processes can be interleaved with simulation analysis processes and/or logical analysis processes. For example, once the physical layout of the circuit design has been modified using resolution enhancement techniques, then a design rule check process or design-for-manufacturing process may be performed on the modified layout, Further, these processes may be alternately repeated until a desired degree of resolution for the design is obtained. Similarly, a design rule check process and/or a design-for-manufacturing process may be employed after an optical proximity correction process, a phase shift mask simulation analysis process, an etch simulation analysis process or a planarization simulation analysis process. Examples of electronic design tools that employ one or more of the logical analysis processes, geometry analysis processes or simulation analysis processes discussed above are described in U.S. Pat. No. 6,240,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

Process Variation Effects and Process Sensitive Devices

Technology scaling has increased the layout dependent systematic variability. The layout dependent systematic variability are dominated by lithography and stress-related effects that have a spatial range of 200 nm-1000 nm and of 1000 nm, respectively. These large interaction ranges make it very difficult to account for variations in performance at the cell level using conventional design rules as the layout context around the cell is unknown. Lithography effects include linewidth variations caused by the proximity effect at nominal process condition and by process variations. OPC is used to reduce the former. While OPC reproduces the intended design shapes on wafer as best as possible, it is not perfect for reasons including mask rule constraints, model fidelity and idiosyncrasies of the OPC algorithm. The residual OPC errors may be extracted and analyzed with a timing model for further correction, as described in “Advanced Timing Analysis Based on Post-OPC Extraction of Critical Dimensions” by Yang et al, in ACM/IEEE Design Automation Conference, 2005, which is incorporated herein by reference.

The present invention concerns the lithography effects caused by process variations and the stress effects, which may have more significant impact on device performance. Process variations associated with the lithography effects include three categories of variations: dose, focus, and mask size. Lithography simulation enables estimation of linewidth variation at different process points. According to some embodiments of the invention, a change in dose of +/−3% and defocus of 100 nm are used for lithography siomulation.

Yet lithography simulation alone is not sufficient in many situations. Across chip linewidth variation (ACLV) can lead to both functional and parametric yield losses. For example, various analog and digital circuits that rely on transistor matching can easily fail in the presence of process variation-induced device mismatch. Even being functionally correct, many chips may not meet the power or performance (such as timing) requirement of the design due to fluctuations in process parameters. Among the large set of process parameters that can impact the performance and power or the design, channel length and threshold voltage for a transistor are the most significant. Therefore, information derived by the lithography simulation needs to be associated with electrical properties.

Various devices models have been developed to calculate electrical properties. The reference, “Full-Flow for Transistors Simulation Based on Edge-Contour Extraction and Advanced SPICE Simulation” by Shauly et al. in Proceedings of SPIE Vol. 7275 (2009) (referred to as Shauly et al. hereafter), which is incorporated herein by reference, describes a method of determining on and off-currents for transistors using a contour-based transistor characterization. With various implementations of the invention, the equivalent gate dimension may not need to be computed because the method described in Shauly et al. can calculate current directly from the simulated contours for transistors even with non-rectangular gates. By deriving electrical properties for devices on various process conditions, devices that do not meet the specification on one or more process conditions may be referred to as process sensitive devices. According to some embodiments of the invention, transistors with process-induced ON current variation greater than or equal to 10% relative to nominal current are defined as process sensitive devices. While transistors are discussed, it should be noted that the term “devices” can include other circuit elements or instances such as capacitors and resistors. It may also include high-level instances such as cells.

Similar to lithographic process variations, mechanical stress effects in the layout can induce variations in the electrical performance of transistors in a design. Variations may include changes in the transistor voltage threshold, saturation velocity and mobility. Consequently, standard cells used in a design can suffer from variability in timing and power performance. The stress effects may be estimated using simulation tools such as a stress simulator in the Calibre family of software tools available from Mentor Graphics Corporation, Wilsonville, Oreg. The stress simulator predicts stress everywhere in a layout design caused by a variety of sources, including stressed liners, epi-SiGe structures confined in the source/drain regions, tensile VIAs and shallow trench isolation (STI). These sources are located inside a floating window surrounding each gate that would extend up to 4000 nm from each side of the transistor. The calculated stress is then used with a pre-calibrated model to calculate the change in the drive current caused by both mobility and threshold voltage (Vth) changes due to stress effects. Devices that do not meet certain specifications identified by the stress simulator may be designated as process sensitive devices.

Design Critical Devices

Although every device in the layout suffers from process variation to some extent, only a small set of devices are critical in the design. These devices could be critical because they are on the timing critical path, prone to variation because of matching constraints (e.g. sense amplifiers or analog devices), or prone to crosstalk. These devices may be extracted from the design using various established tools. To extract transistors in the cells on a timing critical path, the static timing analysis may be applied. The static timing analysis can identify timing critical paths and assign tolerance for each path. Based on the information of timing critical paths, design critical devices may be extracted. For example, devices on the worst negative slack path may be defined as design critical devices.

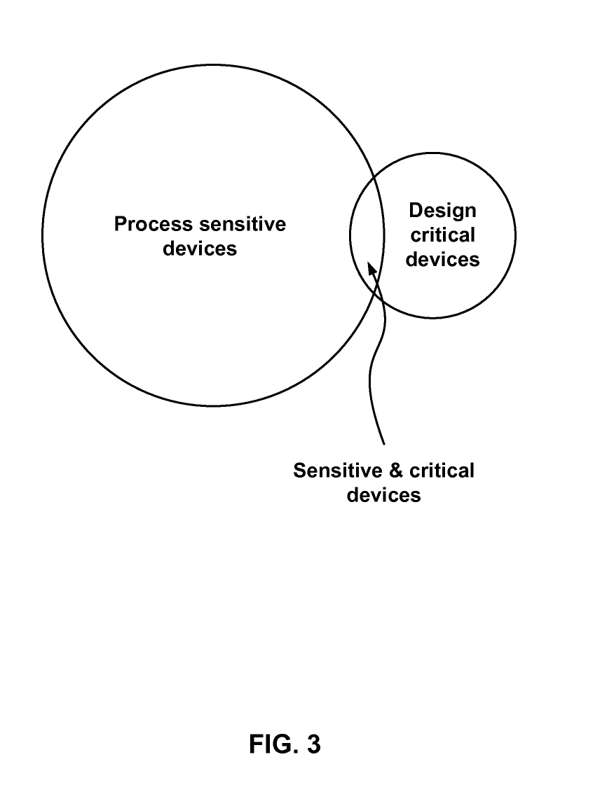

While the number of design critical devices is significantly smaller than that of process sensitive devices, the number of devices that are both design critical and process sensitive is even smaller, as illustrated in FIG. 3. This is especially true for large designs. To make the process of improving circuit design robustness more efficient, model simulations such as lithography and stress simulations may focus on design critical devices, in particular at the early stage of the process. To illustrate this concept, design critical devices and process sensitive devices are extracted from three designs using an industrial 45 nm technology. Both lithography and stress models are calibrated to best match the silicon results. A change in dose of +/−3% and defocus of 100 nm are employed for lithography simulation. Transistors with process-induced ON current-variation>=10% relative to nominal current are considered to be sensitive. Devices on the worst negative slack path may be defined as design critical devices. It should be appreciated that the following are just examples and should not be used to limit the scope of the claimed invention.

Table I. shows distribution of critical and sensitive cells in a circuit design developed at Mentor Graphics Corporation. The design has over 5.5 million transistors and around 300,000 cells. Here, only lithography variation is considered. Around 50,000 of the instances are identified as process sensitive, and among them, only 15 are both sensitive and critical. The set of critical and sensitive instances belongs to 9 library cells with two of them (A12 and A13) contributing 8 instances to the set. These two cells were also sensitive in most of their instances in the full design—indicating that these cells are sensitive to process variation regardless to their context. Other cells showed strong dependence on their context, this was deduced from their number of sensitive instances compared to their total number.

TABLE I
Distribution of critical and sensitive cells

| | Cell | | | | | | | | |
|---|---|---|---|---|---|---|---|---|---|
| | A8 | A11 | A12 | A17 | A30 | A31 | A32 | A33 | A34 |
| Critical | 1 | 1 | 6 | 1 | 1 | 3 | 1 | 1 | 1 |
| C&S | 1 | 1 | 5 | 1 | 1 | 3 | 1 | 1 | 1 |
| Sen- | 412 | 228 | 307 | 66 | 83 | 355 | 112 | 46 | 53 |
| sitive | | | | | | | | | |
| Layout | 461 | 228 | 307 | 71 | 121 | 496 | 131 | 93 | 53 |

The S13207 design of the ISCAS'89 benchmark designs has 23562 transistors. 50% of the transistors are identified to be process sensitive. Among these sensitive transistors only 77 (0.7%) are also critical in timing. 74 transistors of these critical and sensitive transistors are due to stress effects and only 3 are due to lithography effects. These 77 critical and sensitive transistors are in 16 instances of the 2484 instances (cells) in this small design. The b22 design of the ITS'99 benchmark circuits is composed of 62437 transistors. 47% of the transistors are sensitive but only 93 are critical and sensitive.

The results for all the three designs show that only a very small fraction of process sensitive devices is critical for the circuit performance.

Method and Tool for Design Robustness Analysis

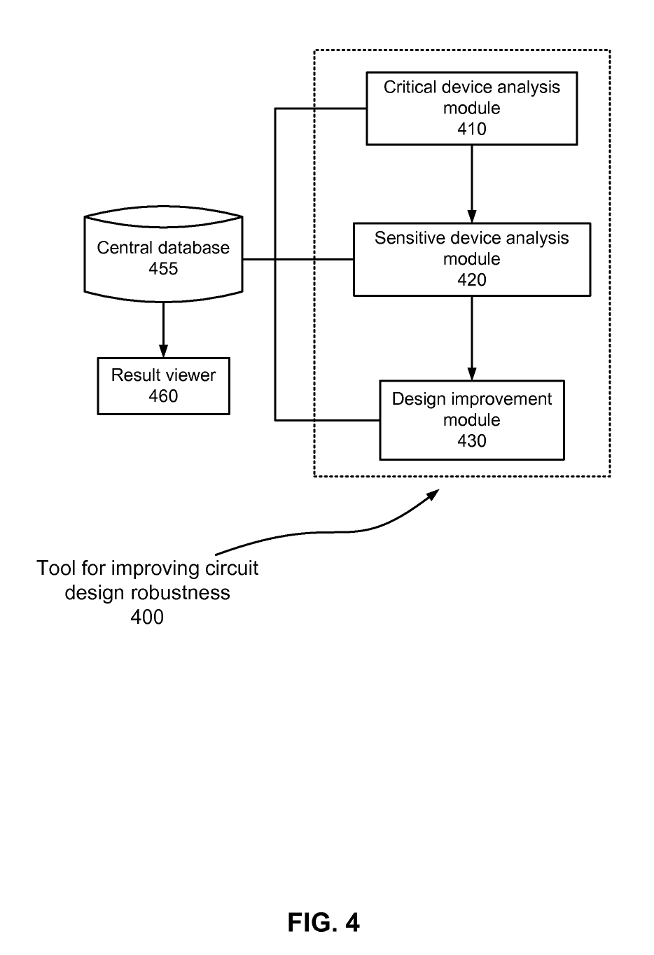

FIG. 4 illustrates an example of a tool for improving circuit design robustness 400 that may be implemented according to various embodiments of the invention. As seen in the figure, the tool 400 includes a critical device analysis module 410, a sensitive device analysis module 420, and a design improvement module 430. As also shown in this figure, various implementations of the tool 400 may cooperate with (or incorporate, in whole or part) a central database 455. The central database 455 may store the layout design, the lithography process information (optical, resist and etch models, and the RET recipes) and the stress models. The central database 455 may also store the layout design's electrical connectivity information derived from the layout design by the tool 400 or supplied by other sources. As will be described in detail below, such an integrated framework helps to bring together the information gained from layout analysis, layout-aware circuit analysis, resolution enhancement and optical proximity correction tools, parasitic extraction, timing estimates, and stress analysis, and to suggest the DFM solution which is optimized within the existing constraints on design time and available data.

For purposes of explanation, methods for improving circuit design robustness according to various embodiments of the invention will be described with reference to the tool 400 shown in FIG. 4. It should be appreciated that these methods may be employed by implementations of a different tool according to various embodiments of the invention. Likewise, it should be appreciated that the tool 400 may be used to perform different methods for improving circuit design robustness according to various embodiments of the invention. Also, various embodiments of the invention may be implemented by processor-executable instructions, stored in a processor-readable medium, for causing one or more processors to perform methods for improving circuit design robustness.

As discussed before, various embodiments of the invention extract devices in the circuit design that are both design critical and process sensitive for improving circuit design robustness. Devices that are design critical may be identified using the critical device analysis module 410 in the tool 400. When only a layout design is available, the module 410 can use a LVS (layout vs schematic) tool to extract a netlist showing the electrical connectivity of the circuit design. Then the module 410 can apply various analysis tools to identify design critical devices. In the case of timing critical devices, for example, the module 410 may perform static timing analysis on the netlist to extract timing-critical paths and tolerance for each path may be calculated. The derived timing information is stored in the central database 455.

To identify process sensitive and design critical devices, the process sensitive analysis module 420 performs lithography simulation, stress simulation or both on the design critical devices identified by the module 410. Based on the simulation results, electrical performance analysis is conducted and the devices that do not meet certain criteria are identified as process sensitive and design critical devices. In the three cases described in the previous section, design critical transistors with process-induced ON current-variation>=10% relative to nominal current are considered to be both process sensitive and design critical.

Once the sensitive and critical devices are identified, the design improvement module 430 may employ various techniques to make the circuit design more robust. In one approach, the module 430 may re-route the critical path to avoid the sensitive device and instead use a device that is not in the sensitive set. This approach attempts to modify the critical set to avoid overlap with the sensitive set. In another approach, the module 430 may replace a sensitive critical device with another device that is less process sensitive. This attempts to remove critical instances from the sensitive set by reducing their process sensitivity. In still another approach, the module 430 may apply post tape-out biasing to this instance for variability reduction as described in “Selective gate-length biasing for cost-effective runtime leakage control” by Gupta et al. in ACM/IEEE Design Automation Conference. 2004, pp. 327-330, which is incorporated herein by reference. In still another approach, selective RET/OPC may also be applied by the module 430 to the sensitive and critical devices as described in “Design intention application to tolerance-based manufacturing system” by Kobayashi et al. in Proc. SPIE. 2010 Vol. 76410L, which is incorporated herein by reference.

As previously noted, various embodiments of the invention may be embodied by a computing system, such as the computing system illustrated in FIG. 1 and FIG. 2. Accordingly, one or more components of each of the critical device analysis module 410, the sensitive device analysis module 420, and the design improvement module 430 may be implemented using one or more processors in a computing system. It should be appreciated that, while these three modules are shown as separate units in FIG. 4, a single computer (or a single processor in a computing system) may be used to implement two or all of these modules at different times. Also, various examples of the invention may be embodied by software-executable instructions, stored on a computer-readable medium, for instructing a computing system to implement one or more components of each of the critical device analysis module 410, the sensitive device analysis module 420, and the design improvement module 430. Further, each module may either be fully automated or allow a user to provide instructions for an operation. Still further, while the central database 455 is shown as a single unit in FIG. 4, multiple computer accessible media may be used to implement this database.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, instead of using single central database, two or more databases may be used. Design critical devices may also include devices that are not timing critical but are critical according to different design intent. Further, approximate modeling techniques may be used to speed up and simplify the simulation tools for identifying process sensitive devices. Once sensitive and critical devices are identified, accurate modeling of these instances may be necessary.

What is claimed is:

1. A method for improving circuit design robustness, comprising:
receiving layout design data for a circuit;
receiving information of design critical devices in the circuit;
analyzing a portion of the layout design data associated with the design critical devices to identify process sensitive and design critical devices; and
storing information related to the process sensitive and design critical devices in a processor-accessible medium.

2. The method recited in claim 1, further comprising:
applying one or more techniques to improve circuit design robustness for the circuit based on the information related to the process sensitive and design critical devices.

3. The method recited in claim 2, wherein one of the one or more techniques is re-routing a critical path to avoid one of the process sensitive and design critical devices.

4. The method recited in claim 2, wherein one of the one or more techniques is replacing one of the process sensitive and design critical devices with a less sensitive device.

5. The method recited in claim 2, wherein one of the one or more techniques is applying post tape-out biasing to one of the process sensitive and design critical devices.

6. The method recited in claim 2, wherein one of the one or more techniques is applying selective RET(resolution enhancement technique)/OPC(optical proximity correction) to one of the process sensitive and design critical devices.

7. The method recited in claim 1, wherein the analyzing a portion of the layout design data associated with the design critical devices to identify process sensitive and design critical devices comprises:
performing one or more lithography simulations using the portion of the layout design data associated with the design critical devices to produce lithography effect information.

8. The method recited in claim 7, wherein the analyzing a portion of the layout design data associated with the design critical devices to identify process sensitive and design critical devices further comprises:
performing an electrical performance analysis using the lithography effect information to identify process sensitive and design critical devices.

9. The method recited in claim 1, wherein the analyzing a portion of the layout design data associated with the design critical devices to identify process sensitive and design critical devices comprises:
performing one or more stress simulations using the portion of the layout design data associated with the design critical devices to produce stress effect information.
identifying process sensitive and design critical devices based on the stress effect information.

10. The method recited in claim 1, wherein the information of design critical devices is derived by analyzing the circuit.

11. The method recited in claim 10, wherein the analyzing the circuit comprises performing static timing analysis.

12. The method recited in claim 10, wherein the analyzing the circuit comprises:
extracting a netlist using the layout design data; and
analyzing the netlist to derive information of design critical devices.

13. A processor-readable medium storing processor-executable instructions for causing one or more processors to perform a method for improving circuit design robustness, the method comprising:
receiving layout design data for a circuit;
receiving information of design critical devices in the circuit;
analyzing a portion of the layout design data associated with the design critical devices to identify process sensitive and design critical devices; and
storing information related to the process sensitive and design critical devices in a processor-accessible medium.

14. A system comprising one or more processors, the one or more processors programmed to perform a method for improving circuit design robustness, the method comprising:
receiving layout design data for a circuit;
receiving information of design critical devices in the circuit;
analyzing a portion of the layout design data associated with the design critical devices to identify process sensitive and design critical devices; and
storing information related to the process sensitive and design critical devices in a processor-accessible medium.
